(19) United States
(12) Patent Application Publication
(10) Pub. No.: US 2015/0240857 A1
(43) Pub. Date: Aug. 27, 2015

(54) FASTENING APPARATUS HAVING ADJUSTABLE TORQUE SETTINGS

(71) Applicant: CHEMSEAL, INC., Hialeah, FL (US)

(72) Inventor: Carlos Simanca, Pembroke Pines, FL (US)

(73) Assignee: CHEMSEAL, INC., Hialeah, FL (US)

(21) Appl. No.: 14/629,522

(22) Filed: Feb. 24, 2015

Related U.S. Application Data
(60) Provisional application No. 61/944,285, filed on Feb. 25, 2014.

(51) Int. Cl. F16B 33/00

(52) U.S. Cl. CPC F16B 33/00

(57) ABSTRACT

The present invention is a fastening apparatus that has an integrated user-selectable torque setting mechanism. The core components of the invention are a threaded fastener, a user-selectable torque setting mechanism, and a housing, which, generally speaking, are configured as follows: the threaded fastener and the torque setting mechanism are aligned axially and rotably coupled, the housing surrounds both the fastener and the torque setting mechanism, is rotably coupled to the torque setting mechanism, and captures both the torque setting mechanism and the fastener in their relative axial positions. The invention can be used to provide secure and consistent fastening of hose clamps in coupled tubing applications. Furthermore, it should be noted that this fastening apparatus may be retrofitted onto existing clamps as well as used in other fastening applications where a user-selectable torque setting is desired.

### CROSS-REFERENCE TO RELATED APPLICATIONS

This U.S. Non-Provisional patent application claims the benefit of the currently Pending, U.S. Provisional Patent Application No. 61/944,285, filed on 25 Feb. 2014, and is incorporated by reference as if fully set forth herein.

### FIELD OF THE INVENTION

This invention relates generally to the field of fasteners, and, more particularly, to a fastening apparatus having adjustable torque settings.

### BACKGROUND

Fasteners are used in many applications where it is desirable to join two or more surfaces or components together. In order for fasteners to function properly, it is imperative that they be tightened to the proper torque. Too loose and the joint or seal may be compromised. Too tight and the fastener could impart high stresses into the system or even break. An example of this is in the field of fluid couplings. With fluid couplings, two couplings are mated with a rubber gasket, or seal, and the coupling is held together with a clamping system. In this application, the proper tightening of the clamping system is necessary in order to maintain the integrity of the seal. If the clamp is not tightened sufficiently, the seal will leak due to insufficient clamping force. If the clamp is over-tightened, the gasket will be over-compressed and pushed into the fluid path, or otherwise damaged, and also compromise the quality of the seal. It is therefore important in this, and other applications, to properly tighten a fastener to achieve the clamping force required for the particular application for which it is being used.

Some solutions have attempted to address the problems addressed above by providing a system or apparatus that includes a means by which to prevent over- or under-tightening of a fastener on a clamp.

Commonly, proper torque settings are achieved by utilizing a separate “torque-driver” or other tool by which the fastener can be tightened to a desired torque value.

Other solutions attempt to address the problem by providing for a specialized clamp-fastener assembly that allows for multiple compression settings.

Information relevant to attempts to address the problems found in the current state of the art, as described above, can be found in U.S. Pat. No. 8,220,113. However, this reference, as well as others known in the art, suffer from one or more of the following disadvantages: the requirement of the use of a torque driver or other specialized tool; the multiple compression settings are related to thread travel and not fastener torque; the system includes, and requires, a proprietary clamp and is not able to be retrofitted to existing clamps;

It would, therefore, be desirable to have a fastening apparatus that provides for user-selectable torque settings. Furthermore, it would also be desirable to have a fastening apparatus with a user-selectable torque setting that does not require tools. Still further, it would be desirable to have fastening apparatus with a user-selectable torque setting that can be retrofitted into existing clamping mechanisms. Therefore, there currently exists a need in the industry for a fastening apparatus with a user-selectable torque setting that can be used without tools, and may be retrofitted into existing clamping mechanisms.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

The present invention is directed to an apparatus that satisfies the need for a fastener with a user-selectable torque setting that can be used without tools, and may be retrofitted into existing clamping mechanisms.

With respect to the apparatus, embodiments thereof provide for a fastening apparatus having adjustable torque settings, which is made up of the following components: a threaded fastener which is substantially cylindrical, including a central axis extending longitudinally through the center of the fastener, a proximal end with a flanged surface protruding perpendicular to the central axis, a distal end, and a bearing surface extending perpendicular to the central axis and located between the distal end and the flanged proximal end; an adjustable torque setting mechanism with a first end and a second end; a housing with a distal end, a proximal end, an inner surface, and an outer surface, wherein said inner surface incorporates features for capturing both the threaded fastener and the torque setting mechanism in axial alignment and axial engagement, and wherein said outer surface incorporates features for a user to grip and turn the fastening apparatus by hand. These components are related as follows: the adjustable torque setting mechanism is aligned axially with the central axis of the threaded fastener where said first end is rotably coupled to the proximal end of the threaded fastener; the housing surrounds the threaded fastener and torque setting mechanism, capturing both the threaded fastener and the torque setting mechanism in axial alignment and axial engagement, where said first end of torque setting mechanism is cooperatively located with the proximal end of the housing and the distal end of the threaded fastener is cooperatively located with respect to the distal end of the housing such that said bearing surface is positioned outside of the housing along the central axis, and said housing is rotably coupled to the torque setting mechanism.

Certain embodiments of the present invention may be used for, but not limited to, the joining of sanitary fluid couplings, hoses, pipes and the like, where the tightness of the joint is important for the performance of the system. It is contemplated, however, that use of certain embodiments of the present invention in other applications beyond fluid couplings, is within the scope of the present invention. For example, the fastener may be used to attach wheels, coupled plates, and the like.

Embodiments of the present invention may include components manufactured from various materials based upon the contemplated use. Metals such as steel, stainless steel, or aluminum, and plastics such as nylon or ABS may be used.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a composite of various orthographic projection views in accordance with an embodiment of the present invention showing a fastening apparatus having adjustable torque setting;

FIG. 2 is an exploded perspective view in accordance with an embodiment of the present invention showing a fastening apparatus having adjustable torque setting;

FIG. 3 is a composite of various orthographic projection views in accordance with an embodiment of the present invention showing nut-threaded fastener;

FIG. 4 is a composite of various orthographic projection views in accordance with an embodiment of the present invention showing a bolt-threaded fastener;

FIG. 5 is an exploded perspective view in accordance with an embodiment of the present invention showing various components comprising a torque setting mechanism subassembly;

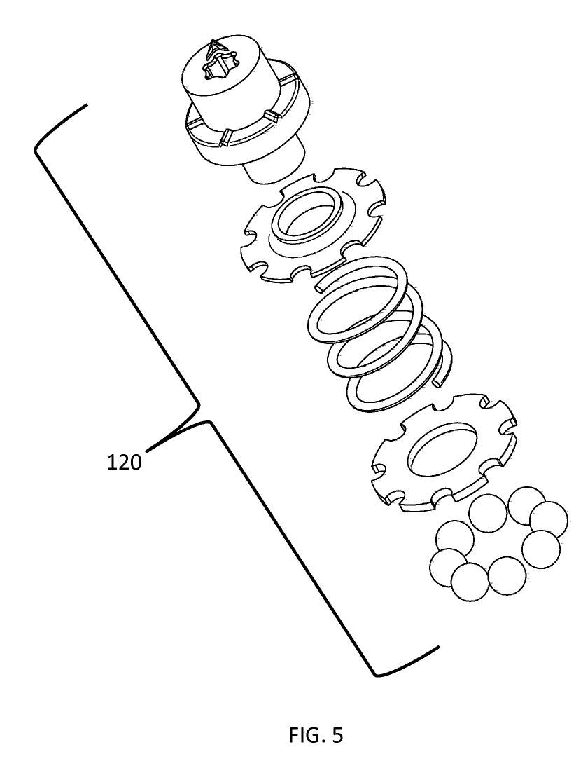

FIG. 6 is a composite of various orthographic projection views in accordance with an embodiment of the present invention showing a ball basket;

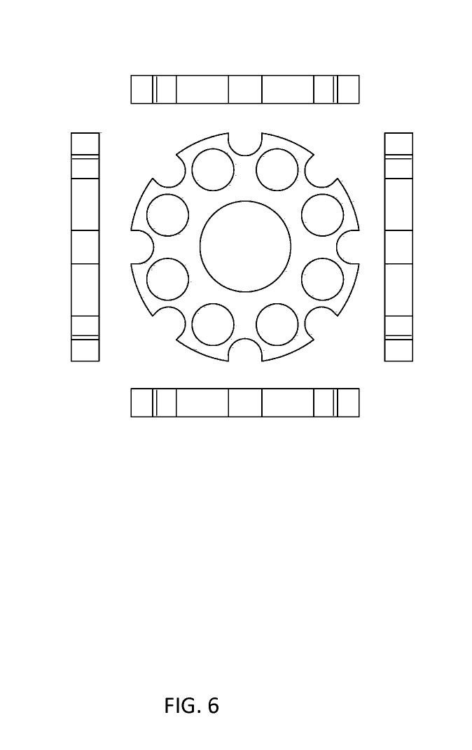

FIG. 7 is an exploded perspective view in accordance with an embodiment of the present invention showing a housing case and a housing cap;

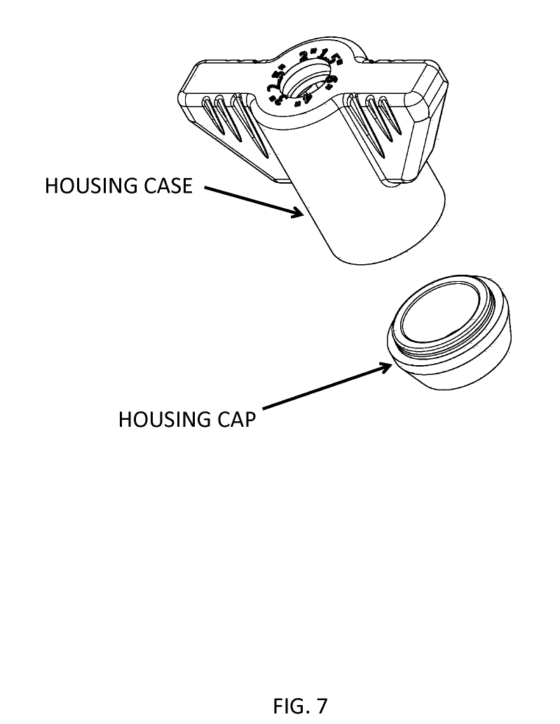

FIG. 8 is a composite of various orthographic projection views in accordance with an embodiment of the present invention showing a housing cap;

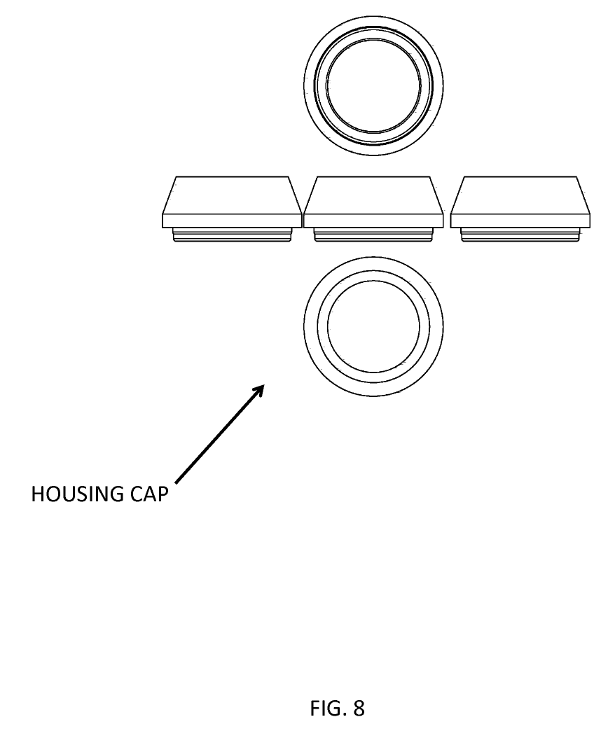

FIG. 9 is a composite of various orthographic projection views in accordance with an embodiment of the present invention showing a housing case;

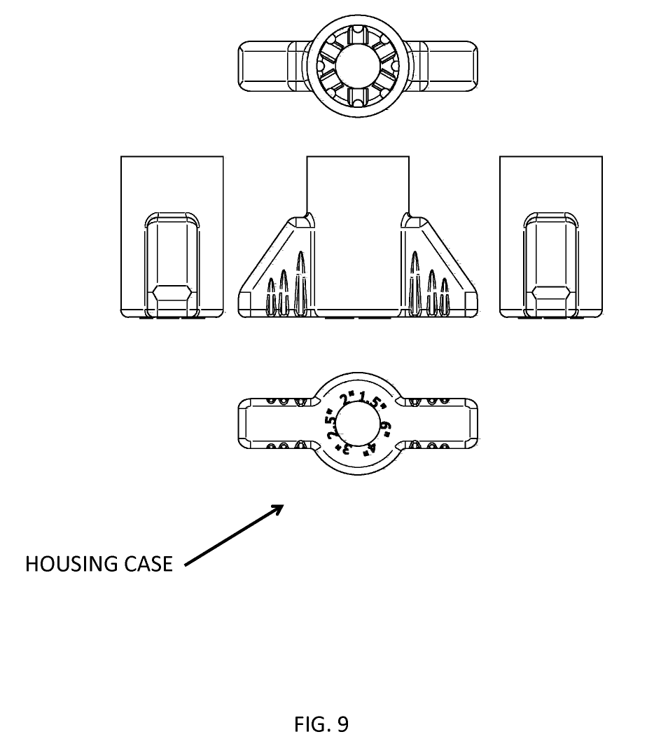

FIG. 10 is a composite of various orthographic projection views in accordance with an embodiment of the present invention showing a dial bolt;

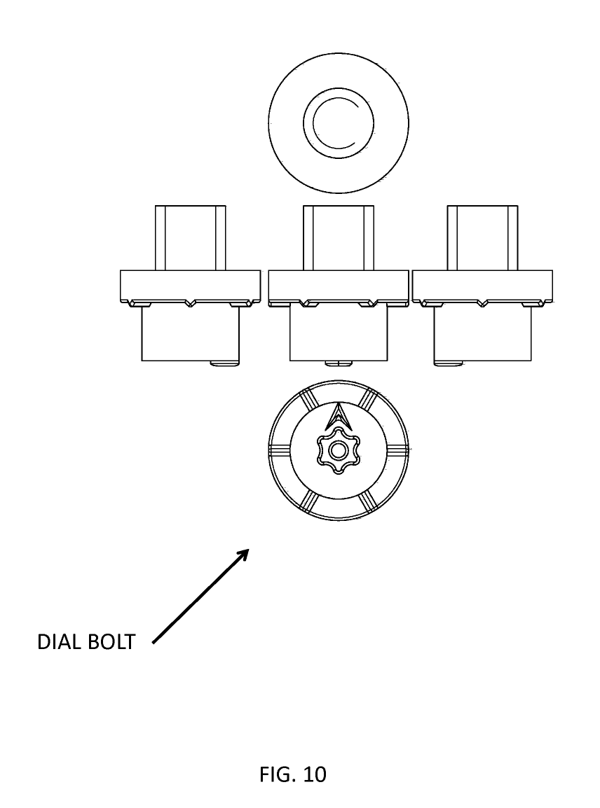

FIG. 11 is a composite of various orthographic projection views in accordance with an embodiment of the present invention showing a threaded washer; and

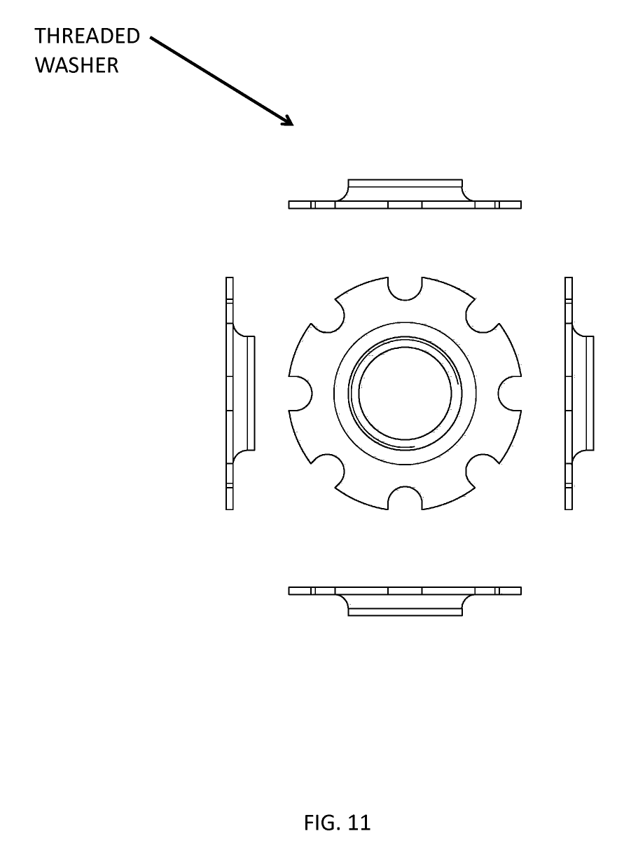

FIG. 12 is a composite of various orthographic projection views in accordance with an embodiment of the present invention showing a washer.

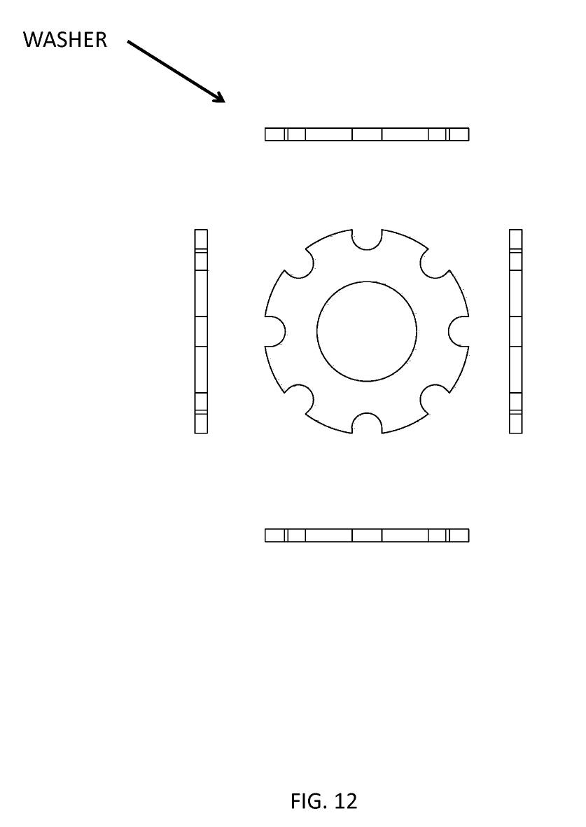

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C but also one or more other components or structures.

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

While this specification concludes with claims defining the features of embodiments of the invention that are regarded as novel, it is believed that the invention will be better understood from a consideration of the following description in conjunction with the figures, in which like reference numerals are carried forward.

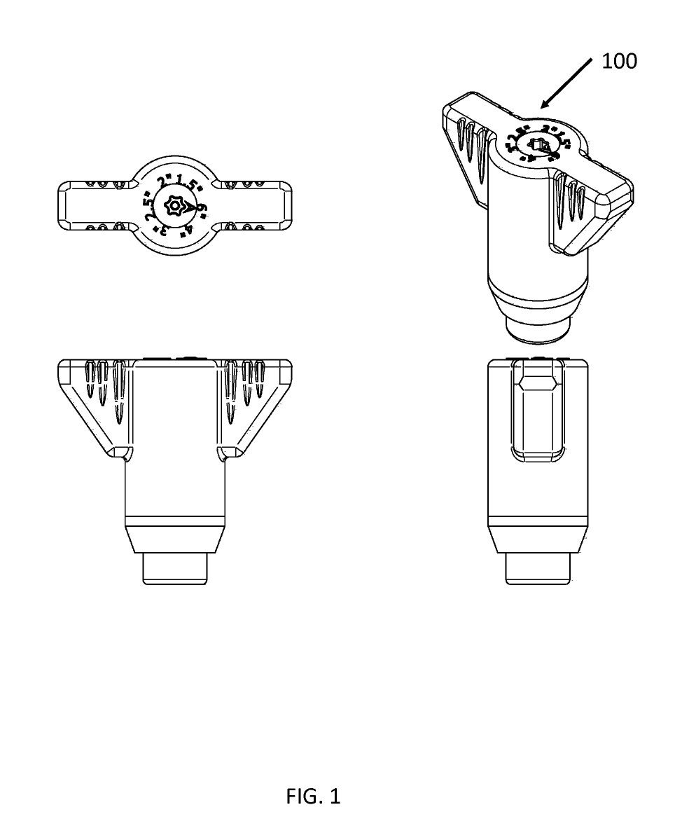

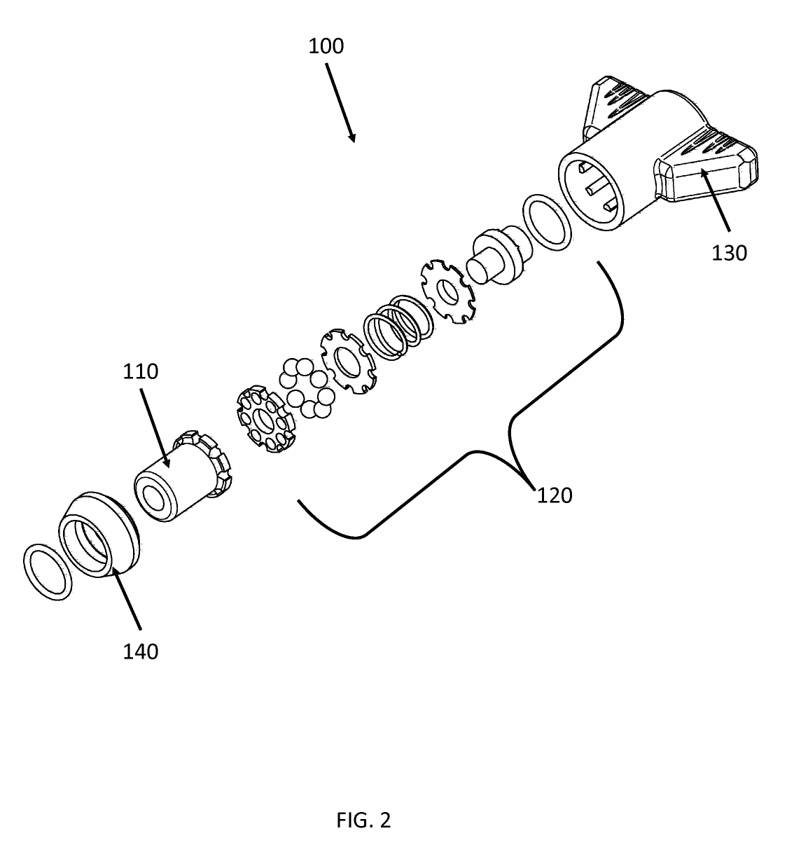

Referring to FIGS. 1 and 2, a preferred embodiment of the present invention is in the form of a fastening apparatus 100 having adjustable torque settings, which is made up of the following components: a threaded fastener 110 which is substantially cylindrical, including a central axis extending longitudinally through the center of the fastener, a proximal end with a flanged surface protruding perpendicular to the central axis, a distal end, and a bearing surface extending perpendicular to the central axis and located between the distal end and the flanged proximal end; an adjustable torque setting mechanism 120 with a first end and a second end; a housing case 130 with a distal end, a proximal end, an inner surface, and an outer surface, wherein said inner surface incorporates features for capturing both the threaded fastener and the torque setting mechanism in axial alignment and axial engagement, and wherein said outer surface incorporates features for a user to grip and turn the fastening apparatus by hand. FIGS. 1 and 2 show an embodiment of the present invention where the threaded fastener 110 and the adjustable torque setting mechanism 120 are constrained within the housing case 120 by a housing cap 140. These components are related as follows: the adjustable torque setting mechanism 120 is aligned axially with the central axis of the threaded fastener 110 where said first end is rotably coupled to the proximal end of the threaded fastener; the housing case 130 surrounds the threaded fastener 110 and torque setting mechanism 120, capturing both the threaded fastener and the torque setting mechanism in axial alignment and axial engagement, where said first end of torque setting mechanism is cooperatively located with the proximal end of the housing and the distal end of the threaded fastener is cooperatively located with respect to the distal end of the housing such that said bearing surface is positioned outside of the housing along the central axis, and said housing is rotably coupled to the torque setting mechanism.

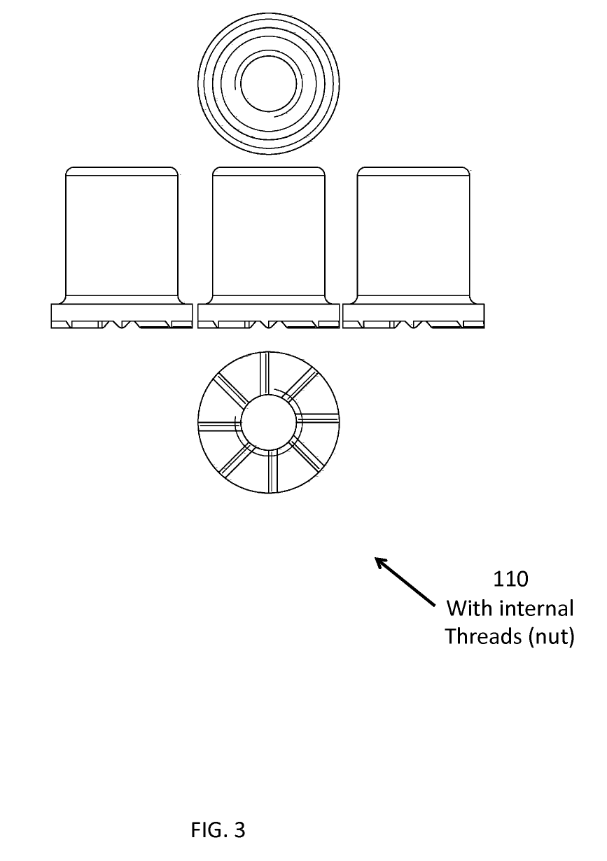

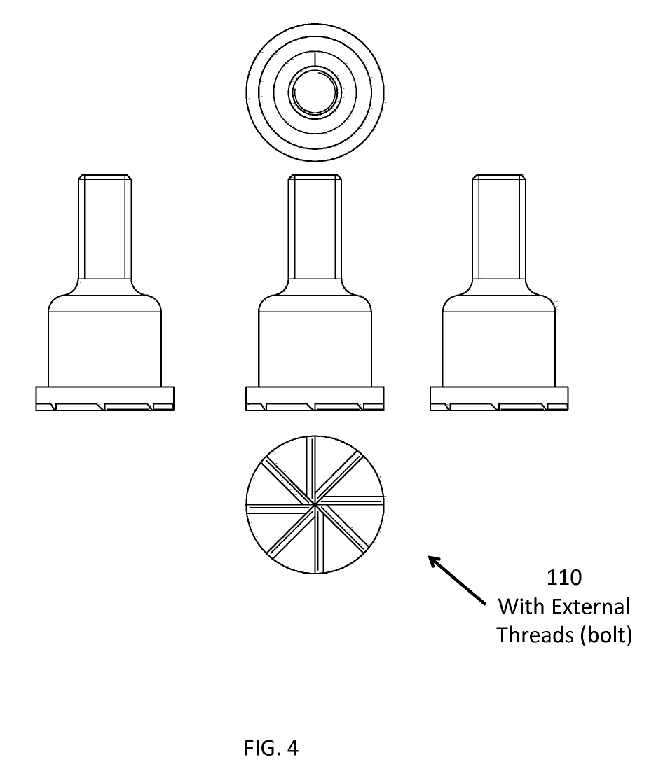

Embodiments of the present invention may also have one or more of the following: the threaded fastener 110 portion may have internal threads, an embodiment of which is shown in FIG. 3; the threaded fastener 110 portion may have external threads, an embodiment of which is shown in FIG. 4; the torque setting mechanism 120 may have features that allow a user to manually dial the desired setting; the torque setting mechanism 120 may have features that require a user to use a key, or tool, to dial the desired setting; the outer surface of the housing 130 may be knurled; the outer surface of the housing 130 may have wings; the outer surface of the housing 130 may have bearing surfaces to accept a tool such as a standard ratchet driver.

It is contemplated as part of the present invention that embodiments thereof may employ various manufacturing methods in order to create the various components of the apparatus. Embodiments of the present invention include, but are not limited to: housings that are made from injection molded plastics, cast metals, or machined metals; fasteners that are made from cast, turned, or machined metals, or molded plastics.

It is further contemplated as part of the present invention that embodiments thereof may comprise a user-selectable torque setting fastener apparatus that can be retrofitted into an existing clamping mechanism, the apparatus comprising: a threaded fastener, which is chosen so as to be able to be operatively coupled to the existing clamping mechanism; a user-selectable torque setting mechanism, which is operatively coupled to the threaded fastener; and a housing, where the housing surrounds at least a portion of the threaded fastener and the user-selectable torque setting mechanism. In this way, for example, a wing nut, or other fastener as is known in the art, may be replaced with a user-selectable torque setting faster, in accordance with an embodiment of the present invention. This would be desired in applications where a clamp is already employed, but the end-user desires a better fastening means. The old wing nut may be discarded, and a fastener according to an embodiment of the present invention may be chosen so as to have the same thread pitch and diameter in order to replace it. In this way, and embodiment of the present invention may save time, money, and aggravation as it can be retrofitted into existing clamping systems.

Another embodiment of the present invention contemplates a fastening system where the system is comprised of an integrated method and apparatus for carrying out the method. In this embodiment, the system would comprise the method steps of: providing a threaded fastener apparatus, where said threaded fastener apparatus comprises a threaded fastener portion, a user-selectable torque setting mechanism portion, and a housing portion; selecting a desired torque setting on the threaded fastener apparatus; coupling the threaded fastener apparatus to a clamping fastener; and rotating the threaded fastener apparatus until the threaded fastener apparatus comes to bear against a bearing surface and the user-selectable torque setting mechanism restricts further rotation.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. A fastening apparatus, the apparatus comprising:
a threaded fastener, which is substantially cylindrical, including a central axis extending longitudinally through the center of the fastener, a proximal end with a flanged surface protruding perpendicular to the central axis, a distal end, and a bearing surface extending perpendicular to the central axis and located between the distal end and the flanged proximal end;
an adjustable torque setting mechanism, with a first end and a second end; and
a housing with a distal end, a proximal end, an inner surface, and an outer surface, wherein said inner surface incorporates features for capturing both the threaded fastener and the torque setting mechanism in axial alignment and axial engagement, and wherein said outer surface incorporates features for a user to grip and turn the fastening apparatus by hand.

2. The threaded fastener of claim 1, wherein said threaded fastener is internally threaded to operate as a nut.

3. The threaded fastener of claim 1, wherein said threaded fastener is externally threaded to operate as a bolt.

4. A user-selectable torque setting fastener apparatus that can be retrofitted into an existing clamping mechanism, the apparatus comprising:
a threaded fastener, which is chosen so as to be able to be operatively coupled to the existing clamping mechanism;
a user-selectable torque setting mechanism, which is operatively coupled to the threaded fastener; and
a housing, where the housing surrounds at least a portion of the threaded fastener and the user-selectable torque setting mechanism.

5. The housing of claim 4, where said housing further comprises a one or more gripping features.

6. A fastening system, where said fastening system is comprised of an integrated method and apparatus for carrying out the method, the fastening system comprising the method steps of:
providing a threaded fastener apparatus, where said threaded fastener apparatus comprises a threaded fastener portion, a user-selectable torque setting mechanism portion, and a housing portion;
selecting a desired torque setting on the threaded fastener apparatus;
coupling the threaded fastener apparatus to a clamping fastener; and
rotating the threaded fastener apparatus until the threaded fastener apparatus comes to bear against a bearing surface and the user-selectable torque setting mechanism restricts further rotation.
